(19) United States
(12) Patent Application Publication
(10) Pub. No.: US 2025/0232206 A1
(43) Pub. Date: Jul. 17, 2025

(54) Quantum and Contrastive Learning Based Vulnerability Identification

(71) Applicant: Bank of America Corporation, Charlotte, NC (US)

(72) Inventors: Ravi Kumar Tadi, Hyderabad (IN); Anmol Puri, Haryana (IN); Ripul Gupta, Kashmir (IN); Vijay Kumar Battiprolu, Hyderabad (IN); Ankit Ashok Tiwari, Maharashtra (IN)

(21) Appl. No.: 18/414,558

(22) Filed: Jan. 17, 2024

(51) Int. Cl. G06N 10/80; G06F 21/57

(52) U.S. Cl. CPC G06N 10/80; G06F 21/577; G06F 2221/033

(57) ABSTRACT

Quantum-based vulnerability and risk identification systems and processes are disclosed that identify vulnerabilities in configuration items (CIs) before changes are deployed. A contrastive learning algorithm compares vectors of CIs to vectors of known vulnerable components and further refines the most relevant features from those filters. Federated Learning enhances model performance, and a quantum optimization system (QOS) optimizes the results generated by the contrastive model as it has an advantage of solving optimization problems formulated with distinct variables. Proactive prediction mechanism is provided through contrastive learning. QOS provides enhanced vulnerability detection system and change management lifecycle. QOS provides deterministic results by finding optimized solutions in high-dimensional solution spaces.

### TECHNICAL FIELD

The present disclosure relates to data processing—artificial intelligence and, more particularly, to systems, methods, and apparatus for using artificial intelligence to identify vulnerabilities in configuration items before software deployment by a quantum-based and contrastive learning-based vulnerability identification system.

### DESCRIPTION OF THE RELATED ART

A software configuration item (CI) is any piece of software that is treated as a single entity for the purposes of configuration management. This includes source code, object code, executables, libraries, documentation, and test data. CIs are typically identified by a unique name or identifier, and they may be grouped together into larger units called configuration items (CIs).

CIs are managed by a configuration management system (CMS), which is a software application that helps to track and control changes to CIs. The CMS stores information about each CI, such as its name, version, and location. It also tracks changes to CIs, and it can be used to revert to previous versions of CIs if necessary.

CIs are important for a number of reasons. They help to ensure that software is consistent and reliable. They also help to make it easier to troubleshoot and fix software problems. Additionally, CIs can be used to track the progress of software development projects.

There are a number of different types of CIs. Some common types of CIs include: source code (human-readable code written by software developers) object code (machine-readable code produced by compiling source code), executables (programs that can be run on a computer), libraries (collections of code that can be used by other programs), documentation (information about software, such as user manuals and technical specifications), test data (data that is used to test software), etc.

CIs can be managed at different levels of granularity. For example, a single CI might be a source code file, or it might be a collection of source code files that make up a software module. The level of granularity at which CIs are managed is typically determined by the organization that is developing the software.

CIs are an important part of software development. They help to ensure that software is consistent, reliable, and easy to maintain.

As systems become more complex, it's increasingly difficult to track all of the changes that are made to them. This can lead to vulnerabilities being introduced into the system without anyone's knowledge.

There are currently a number of tools and techniques available to assist in identifying and remediating vulnerabilities before they are exploited. These are some examples: Static application security testing (SAST) is the process of analyzing an application's source code to identify potential vulnerabilities. Dynamic application security testing (DAST) entails testing an application in a simulated production environment to identify vulnerabilities that attackers can exploit. SCA (software composition analysis) is the process of identifying and assessing the risks associated with third-party libraries used in an application. Vulnerability scanning entails searching a system for known flaws. Penetration testing entails attempting to exploit vulnerabilities in a system in order to identify security flaws.

Vulnerabilities need to be both identified and remediated before any other function or non-functional change is made on applications or CIs. The foregoing approaches to this problem are insufficient in view of rapid changes to system complexity and the constant evolution and development of new applications.

Hence there is a long felt and unsatisfied need to, inter alia, provide a framework that can identify vulnerabilities on applications and configuration items, and can be integrated seamlessly with an enterprise change management system. This will help to identify any vulnerability before a change is deployed to production systems.

### SUMMARY OF THE INVENTION

In accordance with one or more arrangements of the non-limiting sample disclosures contained herein, solutions are provided to address one or more of the shortcomings by, inter alia: (a) using a quantum-based vulnerability and risk identification system to intelligently identify vulnerabilities in CIs before changes are deployed; (b) utilizing a contrastive learning algorithm to compare vectors of CIs to vectors of known vulnerable components and further refine the most relevant features from those filters; (c) using Federated Learning to enhance model performance and using a quantum optimization system to optimize the results given by the contrastive model to solving optimization problems formulated with distinct variables; (d) provide a proactive prediction mechanism through contrastive learning & QOS that will modernize vulnerability detection systems and change management lifecycles; and (e) using QOS to help provide deterministic results by finding optimized solution in high-dimensional solution space.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a centralized storage hub is used to store logs, configuration items, solution repository and change related details. Contrastive learning is used to traverse and identify risk or vulnerabilities in configuration items and augment it with expert analysis. A quantum optimization system provides optimized results given by contrastive learning model and recommends them to change management teams. This quantum based vulnerability identification system can further be integrated with a change management system and proactively suggest the vulnerabilities or risk in CIs before change is implemented.

In some arrangements, a quantum-based risk-identification method to identify configuration vulnerabilities before software changes are deployed in a distributed network can comprise one or more steps such as:
storing, by an artificial intelligence (AI) process in a centralized storage hub, configuration items (CIs), dependencies for the CIs, known vulnerable components, a solution repository, and a change management database;
identifying, by the AI process, a proposed change;
traversing, by the AI process, the centralized storage hub to identify the CIs relevant to the proposed change and relevant dependencies for the CIs relevant to the proposed change;
generating, by the AI process, CI vectors for the CIs and vulnerable vectors for the known vulnerable components;
comparing, by contrastive learning with the AI process, the CI vectors and the vulnerable vectors to form contrastive loss datasets;
training, by the AI process using Federated Learning on the contrastive loss datasets, a learning model;
filtering, the learning model by the AI process, by performing Federated Averaging on the contrastive loss datasets to identify relevant CI features;
encoding, by the AI process using a quantum optimization system (QOS), the relevant CI features into an encoded dataset using an Ising model that is mapped to calculate quantum energy based on the CIs and the proposed change;
optimizing, by the QOS using a quantum circuit on the encoded dataset, to identify an optimal set of CI recommendations that minimizes the quantum energy for the CIs and the proposed change;
storing, by the AI process, the optimal set of CI recommendations in a CI recommendation learning system;
storing, by the AI process in the CI recommendation learning system based on a CI vulnerability prediction, vulnerable CIs and vulnerable dependencies; and
generating, by the AI process based on the vulnerable CIs and the vulnerable dependencies, alerts to identify which of said CIs require remediation prior to said software changes being deployed.

In some arrangements, a quantum-based risk-identification method to identify configuration vulnerabilities before software changes are deployed in a distributed network can comprise one or more steps such as:
storing, by an artificial intelligence (AI) process in a centralized storage hub: configuration items (CIs), dependencies for the CIs, known vulnerable components, a solution repository, and a change management database;
storing, by the AI process in a CI recommendation learning system, optimal sets of CI recommendations as well as vulnerable CIs and vulnerable dependencies based on CI vulnerability predictions;
identifying, by the AI process, a proposed change, unseen CI data logs, and unseen CI functions for the unseen CI data logs;
traversing, the centralized storage hub by the AI process, to identify the CIs relevant to the proposed change and CI dependencies for the CIs relevant to the proposed change;
generating, by the AI process, CI vectors for the CIs and vulnerable vectors for the known vulnerable components;
generating, by the AI process using a quantum optimization system (QOS), an encoded dataset using an Ising model that is mapped to calculate quantum energy based on the CIs and the proposed change;
generating, by the AI process based on the vulnerable CIs and the vulnerable dependencies, alerts to identify which of said CIs require remediation prior to said software changes being deployed;
generating, by the AI process using a trained model, changed sequences, unchanged sequences, predicted vulnerable CIs and predicted non-vulnerable CIs;
comparing, by contrastive learning with the AI process, the CI vectors and the vulnerable vectors to form contrastive loss datasets;
comparing, by the AI process, pairs of vectors with a contrastive loss function;
training, by the AI process using Federated Learning on the contrastive loss datasets and the pairs of vectors, a learning model;
training, by processing of the sequence pairs with an encoder-decoder, the learning model into the trained model;
filtering, by the AI process, the learning model by performing Federated Averaging on the contrastive loss datasets to identify relevant CI features;
encoding, by the AI process using a quantum optimization system (QOS), the relevant CI features into an encoded dataset using an Ising model that is mapped to calculate quantum energy for the CIs and the proposed change;
optimizing, by the QOS using a quantum circuit on the encoded dataset, to identify the optimal sets of CI recommendations that minimizes the quantum energy for the CIs and the proposed change;
optimizing, by the QOS, the initial solution or the new solution depending on whether the new temperature or the initial temperature is lower;
optimizing, by the QOS, the new solution based on the known vulnerable components, the CIs, and the logs;
abstracting, by the AI process, the changed function pairs and the unchanged function into sequence pairs that include an input and a desired output;
abstracting, by the AI process, the unseen ci functions into input sequences;
providing, by the AI process to the trained model, the input sequences;
detecting, by the AI process, unseen CI functions for the unseen CI data logs
importing, by the AI process into the QOS, an initial solution;
evaluating, by the QOS, the initial solution;
estimating, by the QOS, an initial temperature for the initial solution;
generating, by the QOS, a new temperature for a new solution;
comparing, by the QOS, the new temperature to the initial temperature;
adjusting, by the QOS, the new solution based on the known vulnerable components, the CIs, and the logs;
splitting, by the AI process, the contrastive loss datasets into mini batches across distributed nodes with inter-node communication between the distributed nodes; and
executing, by the AI process, a collaborative model to aggregate weight across the mini batches based on the Federated Averaging.

In some arrangements, a quantum-based risk-identification method to identify configuration vulnerabilities before software changes are deployed in a distributed network can comprise one or more steps such as:
storing, by an artificial intelligence (AI) process in a centralized storage hub, configuration items (CIs), known vulnerable components, and proposed changes;
traversing, by the AI process, the centralized storage hub, to identify the proposed changes along with corresponding relevant CIs and relevant dependencies;
training, by the AI process, a trained model by contrastive learning based on the CIs and the known vulnerable components;
predicting, by the AI process using the trained model, vulnerable CIs;
integrating, by the AI process, the vulnerable CIs into a Federated Learning framework;
filtering, by the AI process, the Federated Learning framework using Federated Averaging to identify relevant CI features;
encoding, by the AI process using a quantum optimization system (QOS), the relevant CI features into an encoded dataset using an Ising model that is mapped to calculate quantum energy based on the CIs and the proposed change;
generating, by the QOS based on the encoded dataset, an optimal set of CI recommendations that minimizes the quantum energy for the CIs and the proposed change;
storing, by the AI process, the optimal set of CI recommendations in a CI recommendation learning system;
storing, by the AI process in the CI recommendation learning system based on a CI vulnerability prediction, the vulnerable CIs; and
generating, by the AI process based on the vulnerable CIs, alerts to identify which of said CIs require remediation prior to said software changes being deployed and providing the optimal set of CI recommendations to perform the remediation.

In some arrangements, a quantum-based risk-identification method to identify configuration vulnerabilities before software changes are deployed in a distributed network can comprise one or more steps such as:
creating, by the AI process, pairs of vectors from components of CIs, each of said pairs including a variable component and a fixed component; and
comparing, by the AI process, the pairs of vectors with a contrastive loss function.

In some arrangements, the contrastive loss function is an abstraction differential tree.

In some arrangements, the abstraction differential tree generates changed function pairs that include a vulnerability portion and a fixed portion; and an unchanged function for a non-vulnerable portion.

In some arrangements, a quantum-based risk-identification method to identify configuration vulnerabilities before software changes are deployed in a distributed network can comprise one or more steps such as: abstracting the changed function pairs and the unchanged function into sequence pairs that include an input and a desired output.

In some arrangements, a quantum-based risk-identification method to identify configuration vulnerabilities before software changes are deployed in a distributed network can comprise one or more steps such as: training, the learning model into a trained model, by processing of the sequence pairs with an encoder-decoder.

In some arrangements, a quantum-based risk-identification method to identify configuration vulnerabilities before software changes are deployed in a distributed network can comprise one or more steps such as predicting risks and vulnerabilities by:
importing, by the AI process, unseen CI data logs;
detecting, by the AI process, unseen CI functions for the unseen CI data logs;
abstracting, by the AI process, the unseen CI functions into input sequences;
providing, by the AI process to the trained model, the input sequences; and
generating, by the AI process using the trained model, changed sequences, unchanged sequences, predicted vulnerable CIs and predicted non-vulnerable CIs.

In some arrangements, a QOS is implemented by performing the steps comprising:
inputting, by the AI process into the QOS, an initial solution;
evaluating, by the QOS, the initial solution;
estimating, by the QOS, an initial temperature for the initial solution;
generating, by the QOS, a new temperature for a new solution;
comparing, by the QOS, the new temperature to the initial temperature;
storing, by the QOS, the initial solution or the new solution depending on whether the new temperature or the initial temperature is lower; and
adjusting, by the QOS, the new solution based on the known vulnerable components, the CIs, and the logs.

In some arrangements, natural language processing (NLP) is used by the AI process to identify the vulnerable dependencies underlying the vulnerable CIs.

In some arrangements, the contrastive loss datasets are split by the AI process into mini batches across distributed nodes with inter-node communication between the distributed nodes.

In some arrangements, the AI process executes a collaborative model to aggregate weight across the mini batches based on the Federated Averaging.

In some arrangements, the contrastive learning comprises the steps of creating, by the AI process, pairs of vectors from components of CIs, each of said pairs including a variable component and a fixed component; and comparing, by the AI process, the pairs of vectors with a contrastive loss function.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a functional architecture and flow diagram showing sample interactions, interfaces, steps, functions, and components of a quantum and contrastive learning based vulnerability identification system in accordance with one or more aspects of this disclosure.

FIGS. 2A-2B depict functional architecture and flow diagrams showing sample interactions, interfaces, steps, functions, and components for model training and predicting in accordance with one or more aspects of this disclosure pertaining to traversing-based robustness for vulnerability one-shot prediction.

FIG. 3 depicts a sample Federated Learning Framework for use in accordance with one or more aspects of this disclosure pertaining to a quantum and contrastive learning based vulnerability identification system.

FIG. 4 depicts a functional flow diagram showing sample interactions, interfaces, steps, functions, and components for a quantum optimization system in accordance with one or more aspects of this disclosure.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), quantum circuits, quantum computing, servers, smart devices, streaming servers, tablets, web servers, and/or workstations, which may have one or more application specific integrated circuits (ASICs), microprocessors, cores, executors etc. for executing, accessing, controlling, implementing etc. various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines etc. Other specific or general components, machines, or the like are not depicted in the interest of brevity and would be understood readily by a person of skill in the art.

As used throughout this disclosure, software, computer-executable instructions, data, modules, processes, routines, or the like can include one or more: active-learning, algorithms, alarms, alerts, applications, application program interfaces (APIs), artificial intelligence, approvals, asymmetric encryption (including public/private keys), attachments, big data, CRON functionality, daemons, databases, datasets, datastores, drivers, data structures, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, load balancers, load functionality, machine learning (supervised, semi-supervised, unsupervised, or natural language processing), middleware, modules, namespaces, objects, operating systems, platforms, processes, protocols, programs, rejections, routes, routines, security, scripts, tables, tools, transactions, transformation functionality, user actions, user interface codes, utilities, web application firewalls (WAFs), web servers, web sites, etc.

The foregoing software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

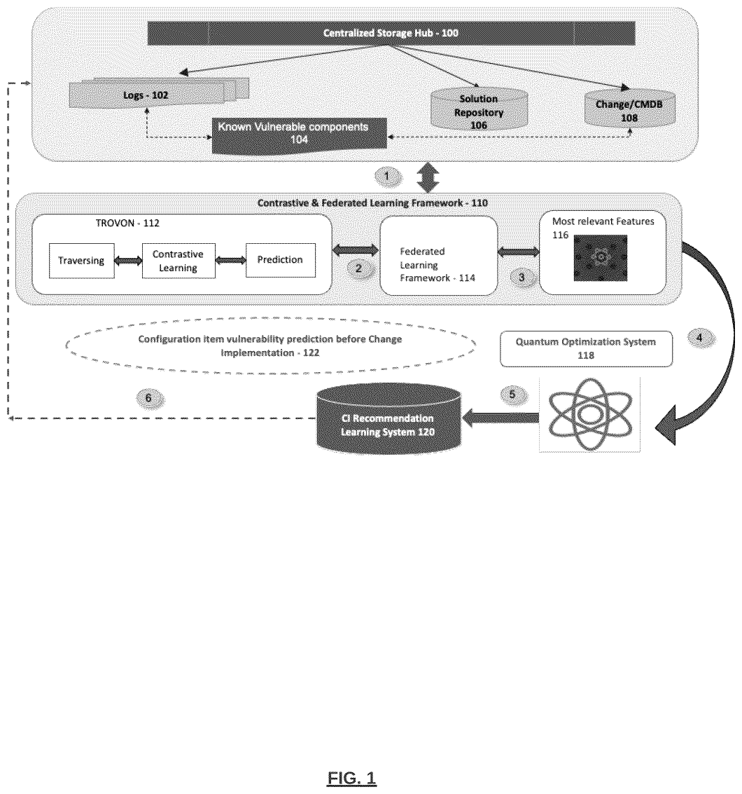

By way of non-limiting disclosure, FIG. 1 depicts a functional architecture and flow diagram showing sample interactions, interfaces, steps, functions, and components of a quantum and contrastive learning based vulnerability identification system in accordance with one or more aspects of this disclosure.

A centralized storage hub 100 includes logs 102 for the CIs, solution repository 106, and a database of changes or a change management database (CMD) 108 that includes change details. Known vulnerable components 104 are reflected in the logs and the CMDB. This interacts with a contrastive and Federated Learning framework 110, which includes three stages.

In the TROVON stage (which stands for traversing-based robustness for vulnerability one-shot prediction), traversing is performed. In this first step, the centralized storage hub is accessed and traversed to identify the applicable components. This is performed by starting from the root of the system and the edges in the dependency graph.

Contrastive learning is the second step in the TROVON stage. Here the system is learning from the known vulnerabilities. This is accomplished by creating a pair of vectors from each CI component (i.e., the variable component and the fixed component). These vectors are compared using a contrastive loss function.

The third step is prediction. The learning model is used to predict the vulnerability of the new CIs. This is accomplished by creating a vector for the new component and comparing it to the vectors of known vulnerable components and their fixed components.

Next, the logs for the vulnerable CIs are traversed using natural language processing (NLP) to find the underlying dependencies and identify their components. This provides multiple datasets splitting for CIs based on their backend dependencies.

A FedAve algorithm is used in the Federated Learning Framework 114 to reach to the highly vulnerable dependences of the CIs. Then this set of CIs, after being filtered for the most relevant features 116, are sent to a quantum optimization system 118 (QOS) for further optimization.

The QOS uses quantum algorithms to solve optimization problems, which involve finding the best solution from a set of possible solutions. Classical computers can solve optimization problems, but they can become intractable for large or complex problems. The QOS can solve optimization problems more efficiently than classical computers.

The QOS uses quantum circuits as blueprints for performing its quantum computations. They are made up of a series of quantum gates, which are operations that can be performed on qubits. Qubits are the basic units of information in quantum computers. They can be in a superposition of states, which means that they can be both 0 and 1 at the same time. This is different from classical bits, which can only be 0 or 1.

The QOS utilizes the principles of superposition and entanglement in quantum mechanics. Superposition is the ability of a qubit to be in a superposition of states. Entanglement is the ability of two or more qubits to be linked together in such a way that they share the same fate. This means that measurement of the state of one entangled qubit, instantly provides knowledge of the state of the other entangled qubits.

The dataset is encoded into a state by using an Ising model, which is a statistical model of a magnetic system. The Ising model consists of a lattice of discrete variables that represent the magnetic dipole moments of atomic “spins” which can be in one of two states: up or down. The spins interact with each other through a combination of nearest-neighbor and next-nearest-neighbor interactions, and they are also subject to an external magnetic field. Each feature in the encoded dataset is represented as a spin in the model and the values are assigned to each piece of the component or CI. Then the overall energy of the system is calculated, which represents how well the CI is met at the change level.

The CI recommendation learning system 120 has vulnerable CIs and their dependencies. It will trigger alerts before any change is created or deployed. This is accomplished by making a CI vulnerability prediction before change implementation 122.

Optimal CI recommendations can be provided by the system 120 to the users who are creating the change that depends on the CI.

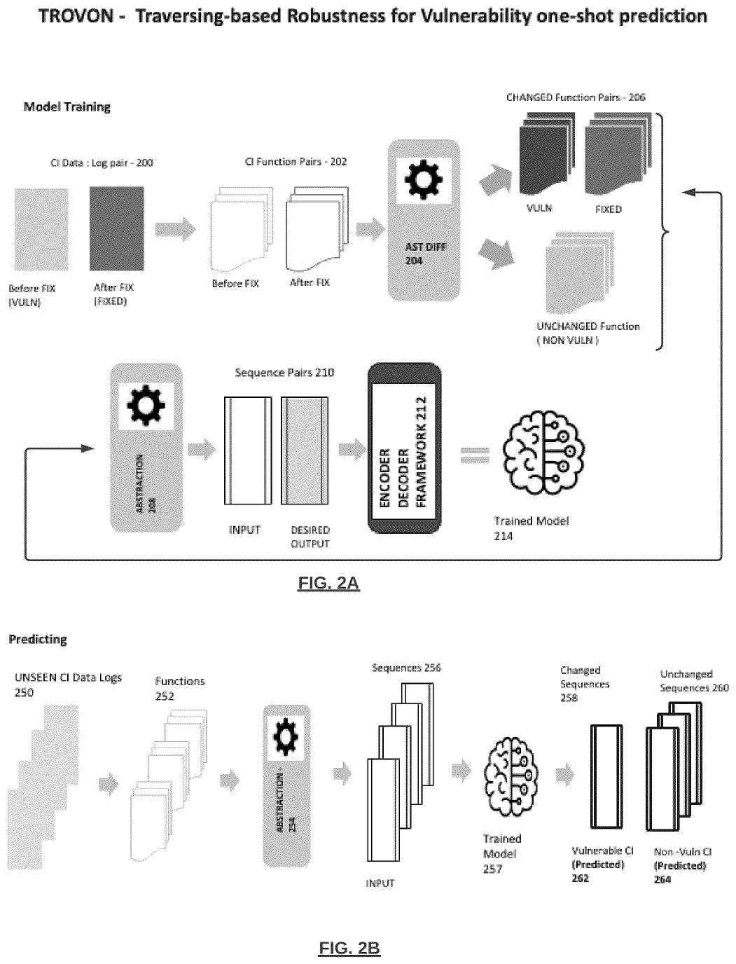

By way of non-limiting disclosure, FIGS. 2A-2B depict functional architecture and flow diagrams showing sample interactions, interfaces, steps, functions, and components for model training and predicting in accordance with one or more aspects of this disclosure pertaining to traversing-based robustness for vulnerability one-shot prediction.

More specifically, FIG. 2A corresponds to model training in the TROVON stage. Two sets of pairs have been used. One is variable sequences with their corresponding fixed sequences and the non-vulnerable sequences paired with themselves. Non-vulnerable sequences are required by the learning model to identify what should not have been changed.

CI data: log pair 200 shows a vulnerability before fix and an after fix data set. CI function pairs 202 have a before fix and after fix that are provided to an abstraction differential tree (AST DIFF) 204, which uses abstract interpretation and differential programming. Abstract interpretation is a static program analysis technique that uses abstract domains to represent sets of possible program states. These abstract domains are typically designed to capture relevant information about the program's behavior without requiring concrete execution. Differential programming is a programming paradigm that uses differential equations to represent and manipulate programs. The AST DIFF combines these two techniques by using abstract domains to represent sets of possible differential equations. This allows the AST DIFF to capture and analyze the behavior of the pairs in a way that is both expressive and accurate to identify changed function pairs 206, which include vulnerabilities, fixes, and unchanged functions. This is then abstracted in 208 into sequence pairs 210 of an input and desired output, which are then encoded/decoded in 212 into a trained model 214.

FIG. 2B shows system prediction in which binary classifiers are used on large quantities of unlabeled historical data, which is why Federated Learning and QOS is utilized to perform optimization and make predictions.

Unseen CI data logs 250 come into the system. Functions 252 operate on the logs. Abstraction 254 is performed to generate sequences 256 that are input into the trained model 257. Changed 258 and unchanged 260 sequences are predicted for vulnerable 262 and non-vulnerable 264 CIs. Once identified, these are passed to the Federated Learning system.

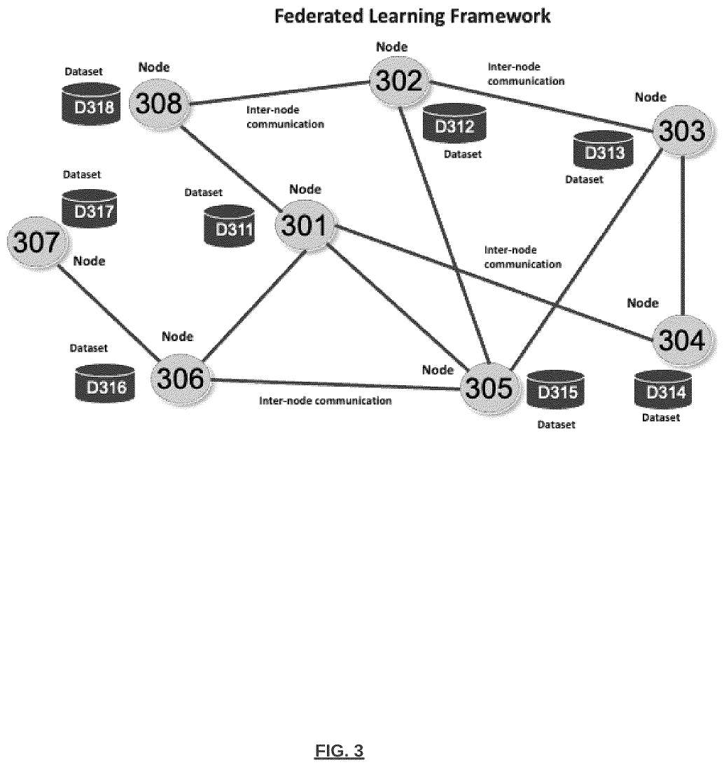

By way of non-limiting disclosure, FIG. 3 depicts a sample Federated Learning Framework for use in accordance with one or more aspects of this disclosure pertaining to a quantum and contrastive learning based vulnerability identification system. As illustrated, NLP is used to identify underlying dependencies for vulnerable CIs. Multiple datasets D311-D318 are split across nodes 301-308. Mini batches can be considered different clients comprising data samples obtained from total data. FedAvg is used and weights (model parameters) tuned on local models are shared. Finally, collaborative model aggregates the final weights of the clients. This reduces the search space by learning the important features.

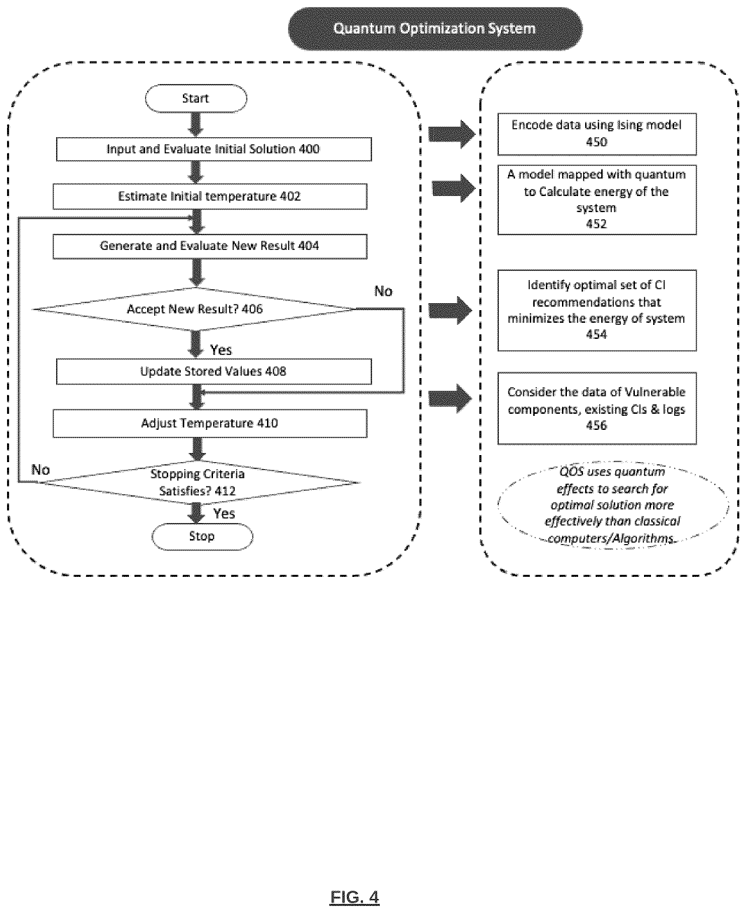

By way of non-limiting disclosure, FIG. 4 depicts a functional flow diagram showing sample interactions, interfaces, steps, functions, and components for a quantum optimization system in accordance with one or more aspects of this disclosure.

Input is received and an initial solution is evaluated in 400. An initial temperature is estimated in 402. A new result is generated and evaluated in 404. If the results is accepted 406, the values are stored in 408. Otherwise, the temperature is adjusted in 410. A determination is made as to whether to stop in 412.

The foregoing corresponds to encoding data using the Ising model 450. The data is encoded into a quantum state. Each feature, all the variables in the dataset, is represented as a spin in the model. The values are assigned to each piece and the values are then used to calculate the overall energy of the system. Hence, the model is mapped with a quantum circuit to calculate the energy of the system 452. An optimal set of CI recommendations that minimize the energy of the system are identified in 454. The data of vulnerable components, existing CIs, and logs are considered in 456. Thus, the QOS is able to use quantum effects to search for an optimal solution more effectively than a classical computer or classical algorithm.

The goal is to find the optimal set of CI recommendations that minimizes the energy of the QOS. The objective function is used to measure the relevance of each feature, such as the CI for the classification task, and weighing the parameters of the Ising model to reach a low energy ground state. The optimal set of recommendations that minimizes the energy of the system is identified.

After the quantum optimization is performed, the final state of the quantum is measured to obtain the most relevant subset. A post-preprocessing step is used to decode the classical states into the feature subsets as shown in the architecture diagram. The optimized recommendations are sent to the CI recommendation learning system, which will identify tell the most vulnerable CI and the most effective dependency of the CI and then alerts will be generated before any changes are deployed. Alerts can be stored in the CMDB.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A quantum-based risk-identification method to identify configuration vulnerabilities before software changes are deployed in a distributed network comprising the steps of:
storing, by an artificial intelligence (AI) process in a centralized storage hub, configuration items (CIs), dependencies for the CIs, known vulnerable components, a solution repository, and a change management database;
identifying, by the AI process, a proposed change;
traversing, by the AI process, the centralized storage hub to identify the CIs relevant to the proposed change and relevant dependencies for the CIs relevant to the proposed change;
generating, by the AI process, CI vectors for the CIs and vulnerable vectors for the known vulnerable components;
comparing, by contrastive learning with the AI process, the CI vectors and the vulnerable vectors to form contrastive loss datasets;
training, by the AI process using Federated Learning on the contrastive loss datasets, a learning model;
filtering, the learning model by the AI process, by performing Federated Averaging on the contrastive loss datasets to identify relevant CI features;
encoding, by the AI process using a quantum optimization system (QOS), the relevant CI features into an encoded dataset using an Ising model that is mapped to calculate quantum energy based on the CIs and the proposed change;
optimizing, by the QOS using a quantum circuit on the encoded dataset, to identify an optimal set of CI recommendations that minimizes the quantum energy for the CIs and the proposed change;
storing, by the AI process, the optimal set of CI recommendations in a CI recommendation learning system;
storing, by the AI process in the CI recommendation learning system based on a CI vulnerability prediction, vulnerable CIs and vulnerable dependencies; and
generating, by the AI process based on the vulnerable CIs and the vulnerable dependencies, alerts to identify which of said CIs require remediation prior to said software changes being deployed.

2. The quantum-based risk-identification method of claim 1 wherein the contrastive learning comprises the steps of:
creating, by the AI process, pairs of vectors from components of CIs, each of said pairs including a variable component and a fixed component; and
comparing, by the AI process, the pairs of vectors with a contrastive loss function.

3. The quantum-based risk-identification method of claim 2 wherein the contrastive loss function is an abstraction differential tree.

4. The quantum-based risk-identification method of claim 3 wherein the abstraction differential tree generates:
changed function pairs that include a vulnerability portion and a fixed portion; and
an unchanged function for a non-vulnerable portion.

5. The quantum-based risk-identification method of claim 4 further comprising the step of abstracting the changed function pairs and the unchanged function into sequence pairs that include an input and a desired output.

6. The quantum-based risk-identification method of claim 5 further comprising the step of training, the learning model into a trained model, by processing of the sequence pairs with an encoder-decoder.

7. The quantum-based risk-identification method of claim 6 further comprising steps for risk prediction that include:
importing, by the AI process, unseen CI data logs;
detecting, by the AI process, unseen CI functions for the unseen CI data logs;
abstracting, by the AI process, the unseen CI functions into input sequences;
providing, by the AI process to the trained model, the input sequences; and
generating, by the AI process using the trained model, changed sequences, unchanged sequences, predicted vulnerable CIs and predicted non-vulnerable CIs.

8. The quantum-based risk-identification method of claim 7 wherein the QOS is implemented by performing the steps comprising:
inputting, by the AI process into the QOS, an initial solution;
evaluating, by the QOS, the initial solution;
estimating, by the QOS, an initial temperature for the initial solution;
generating, by the QOS, a new temperature for a new solution;
comparing, by the QOS, the new temperature to the initial temperature;
storing, by the QOS, the initial solution or the new solution depending on whether the new temperature or the initial temperature is lower; and
adjusting, by the QOS, the new solution based on the known vulnerable components, the CIs, and the logs.

9. The quantum-based risk-identification method of claim 8 wherein natural language processing (NLP) is used by the AI process to identify the vulnerable dependencies underlying the vulnerable CIs.

10. The quantum-based risk-identification method of claim 9 wherein the contrastive loss datasets are split by the AI process into mini batches across distributed nodes with inter-node communication between the distributed nodes.

11. The quantum-based risk-identification method of claim 10 wherein the AI process executes a collaborative model to aggregate weight across the mini batches based on the Federated Averaging.

12. A quantum-based risk-identification method to identify configuration vulnerabilities before software changes are deployed in a distributed network, comprising:
storing, by an artificial intelligence (AI) process in a centralized storage hub: configuration items (CIs), dependencies for the CIs, known vulnerable components, a solution repository, and a change management database;
storing, by the AI process in a CI recommendation learning system, optimal sets of CI recommendations as well as vulnerable CIs and vulnerable dependencies based on CI vulnerability predictions;
identifying, by the AI process, a proposed change, unseen CI data logs, and unseen CI functions for the unseen CI data logs;
traversing, the centralized storage hub by the AI process, to identify the CIs relevant to the proposed change and CI dependencies for the CIs relevant to the proposed change;
generating, by the AI process, CI vectors for the CIs and vulnerable vectors for the known vulnerable components;
generating, by the AI process using a quantum optimization system (QOS), an encoded dataset using an Ising model that is mapped to calculate quantum energy based on the CIs and the proposed change;
generating, by the AI process based on the vulnerable CIs and the vulnerable dependencies, alerts to identify which of said CIs require remediation prior to said software changes being deployed;
generating, by the AI process using a trained model, changed sequences, unchanged sequences, predicted vulnerable CIs and predicted non-vulnerable CIs;
comparing, by contrastive learning with the AI process, the CI vectors and the vulnerable vectors to form contrastive loss datasets;
comparing, by the AI process, pairs of vectors with a contrastive loss function;
training, by the AI process using Federated Learning on the contrastive loss datasets and the pairs of vectors, a learning model;
training, by processing of the sequence pairs with an encoder-decoder, the learning model into the trained model;
filtering, by the AI process, the learning model by performing Federated Averaging on the contrastive loss datasets to identify relevant CI features;
encoding, by the AI process using a quantum optimization system (QOS), the relevant CI features into an encoded dataset using an Ising model that is mapped to calculate quantum energy for the CIs and the proposed change;
optimizing, by the QOS using a quantum circuit on the encoded dataset, to identify the optimal sets of CI recommendations that minimizes the quantum energy for the CIs and the proposed change;
optimizing, by the QOS, the initial solution or the new solution depending on whether the new temperature or the initial temperature is lower;
optimizing, by the QOS, the new solution based on the known vulnerable components, the CIs, and the logs;
abstracting, by the AI process, the changed function pairs and the unchanged function into sequence pairs that include an input and a desired output;
abstracting, by the AI process, the unseen ci functions into input sequences;
providing, by the AI process to the trained model, the input sequences;
detecting, by the AI process, unseen CI functions for the unseen CI data logs
importing, by the AI process into the QOS, an initial solution;
evaluating, by the QOS, the initial solution;
estimating, by the QOS, an initial temperature for the initial solution;
generating, by the QOS, a new temperature for a new solution;
comparing, by the QOS, the new temperature to the initial temperature;
adjusting, by the QOS, the new solution based on the known vulnerable components, the CIs, and the logs;
splitting, by the AI process, the contrastive loss datasets into mini batches across distributed nodes with inter-node communication between the distributed nodes; and
executing, by the AI process, a collaborative model to aggregate weight across the mini batches based on the Federated Averaging.

13. A quantum-based risk-identification method to identify configuration vulnerabilities before software changes are deployed in a distributed network, comprising:
storing, by an artificial intelligence (AI) process in a centralized storage hub, configuration items (CIs), known vulnerable components, and proposed changes;
traversing, by the AI process, the centralized storage hub, to identify the proposed changes along with corresponding relevant CIs and relevant dependencies;
training, by the AI process, a trained model by contrastive learning based on the CIs and the known vulnerable components;
predicting, by the AI process using the trained model, vulnerable CIs;
integrating, by the AI process, the vulnerable CIs into a Federated Learning framework;
filtering, by the AI process, the Federated Learning framework using Federated Averaging to identify relevant CI features;
encoding, by the AI process using a quantum optimization system (QOS), the relevant CI features into an encoded dataset using an Ising model that is mapped to calculate quantum energy based on the CIs and the proposed change;
generating, by the QOS based on the encoded dataset, an optimal set of CI recommendations that minimizes the quantum energy for the CIs and the proposed change;
storing, by the AI process, the optimal set of CI recommendations in a CI recommendation learning system;
storing, by the AI process in the CI recommendation learning system based on a CI vulnerability prediction, the vulnerable CIs; and
generating, by the AI process based on the vulnerable CIs, alerts to identify which of said CIs require remediation prior to said software changes being deployed and providing the optimal set of CI recommendations to perform the remediation.

14. The quantum-based risk-identification method of claim 13 wherein the contrastive learning comprises the steps of:
creating, by the AI process, pairs of vectors from components of CIs, each of said pairs including a variable component and a fixed component; and
comparing, by the AI process, the pairs of vectors with a contrastive loss function.

15. The quantum-based risk-identification method of claim 14 wherein the contrastive loss function is an abstraction differential tree.

16. The quantum-based risk-identification method of claim 15 wherein the abstraction differential tree generates:
changed function pairs that include a vulnerability portion and a fixed portion; and
an unchanged function for a non-vulnerable portion.

17. The quantum-based risk-identification method of claim 16 further comprising the step of abstracting the changed function pairs and the unchanged function into sequence pairs that include an input and a desired output.

18. The quantum-based risk-identification method of claim 17 further comprising the step of training, the learning model into a trained model, by processing of the sequence pairs with an encoder-decoder.

19. The quantum-based risk-identification method of claim 18 further comprising steps for risk prediction that include:
importing, by the AI process, unseen CI data logs;
detecting, by the AI process, unseen CI functions for the unseen CI data logs;
abstracting, by the AI process, the unseen CI functions into input sequences;
providing, by the AI process to the trained model, the input sequences; and
generating, by the AI process using the trained model, changed sequences, unchanged sequences, predicted vulnerable CIs and predicted non-vulnerable CIs.

20. The quantum-based risk-identification method of claim 19 wherein the QOS is implemented by performing the steps comprising:
inputting, by the AI process into the QOS, an initial solution;
evaluating, by the QOS, the initial solution;
estimating, by the QOS, an initial temperature for the initial solution;
generating, by the QOS, a new temperature for a new solution;
comparing, by the QOS, the new temperature to the initial temperature;
storing, by the QOS, the initial solution or the new solution depending on whether the new temperature or the initial temperature is lower; and
adjusting, by the QOS, the new solution based on the known vulnerable components, the CIs, and the logs.
